(19) United States
(12) Patent Application Publication
(10) Pub. No.: US 2024/0250739 A1
(43) Pub. Date: Jul. 25, 2024

(54) BEAM FAILURE RECOVERY IN WIRELESS COMMUNICATION SYSTEMS EMPLOYING MULTIPLE TRANSMISSION/RECEPTION POINTS

(71) Applicant: QUALCOMM Incorporated, San Diego, CA (US)

(72) Inventors: Fang Yuan, Beijing (CN); Yan Zhou, San Diego, CA (US); Tao Luo, San Diego, CA (US)

(21) Appl. No.: 18/558,020

(22) PCT Filed: May 13, 2021
(86) PCT No.: PCT/CN2021/093609

§ 371 Date: Oct. 30, 2023

(51) Int. Cl. H04B 7/06; H04W 72/21

(52) U.S. Cl. CPC H04B 7/06964; H04W 72/21

(57) ABSTRACT

A user equipment (UE) detects beam failure associated with a transmission/reception point (TRP) of a plurality of TRPs transmitting to the UE. Each TRP is associated with separate Physical Uplink Control Channel (PUCCH) resources for beam failure recovery (BFR). The UE applies, in response to detecting, a BFR procedure across PUCCH resources of the TRPs. In some aspects, the procedure is described by a single set of parameters/variable (s) across the PUCCH resources. Further, each of a plurality of TRPs transmits to a UE on a beam. A first of the TRPs receives, from the UE, a scheduling request (SR) in BFR PUCCH resources. The SR indicates that an uplink grant is requested by the UE to transmit beam failure information for at least one failed beam of the TRPs. The SR is a result of a single BFR procedure applied by the UE across the PUCCH resources of the TRPs.

### BACKGROUND

### Technical Field

The present disclosure relates generally to communication systems, and more particularly in some examples, to configuring and executing beam failure recovery scheduling requests of a user equipment (UE) in a wireless network employing multiple transmission/reception points (TRPs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems. These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The technology disclosed herein includes method, apparatus, and computer-readable media including instructions for wireless communication. In some aspects, a user equipment (UE) detects a beam failure associated with at least one transmission/reception point (TRP) of a plurality of TRPs transmitting to the UE. Each TRP is associated with separate Physical Uplink Control Channel (PUCCH) resources for beam failure recovery (BFR). The UE applies, in response to detecting, a BFR procedure across PUCCH resources of the TRPs. In some aspects, the procedure is described by a single set of parameters/variable(s) across the PUCCH resources.

In some examples, the BFR procedure is parameterized by a single sr-ProhibitTimer, a single dsr-TransMax, a single SchedulingRequestId across the PUCCH resources. In some example, multiple BFR PUCCH resources are associated with the BFR procedure. In some examples, applying the BFR procedure includes transmitting a BFR scheduling request (SR) on at least one of BFR PUCCH resources determined by the UE. In some examples, applying the BFR procedure comprises transmitting a BFR scheduling request (SR) on BFR PUCCH resources of a non-failed TRP.

In some examples, the UE receives, by the UE and prior to the applying, a BFR procedure configuration specifying a process for choosing BFR PUCCH resources for transmitting a BFR scheduling request (SR). In such examples, applying the BFR procedure includes choosing BFR PUCCH resources for transmitting a BFR SR in accordance with the received BFR procedure configuration, and transmitting a BFR SR on the chosen BFR PUCCH resource.

In some examples, applying the BFR procedure includes transmitting a BFR scheduling request (SR) on BFR PUCCH resources most recently used by the UE for transmitting a BFR SR. In some examples, applying the BFR procedure includes transmitting a BFR scheduling request (SR) on BFR PUCCH resources other than BFR PUCCH resources most recently used by the UE for transmitting a BFR SR.

In some examples, the UE receives, prior to the applying, a common BFR PUCCH resource configuration for each BFR PUCCH resource and wherein each BFR PUCCH resource comprises a different {periodicity, offset value} pair. In such examples, the UE configures, prior to the applying, each BFR PUCCH resource with the common received configuration and different {periodicity, offset value} pair. In such examples, applying the BFR procedure includes transmitting a BFR scheduling request (SR) on a configured BFR PUCCH resource.

In some examples, the UE receives, prior to the applying, a different BFR PUCCH resource configuration for each BFR PUCCH resource. In such examples, the UE configures, prior to the applying, each BFR PUCCH resource with the corresponding received configuration. In such examples, applying the BFR procedure includes transmitting a BFR scheduling request (SR) on a configured BFR PUCCH resource.

In some aspects, each of a plurality of TRPs transmits to a UE on a beam. A first of the TRPs receives, from the UE, a scheduling request (SR) in BFR PUCCH resources. The SR indicates that an uplink grant is requested by the UE to transmit beam failure information for at least one failed beam of the TRPs. The SR is a result of a single BFR procedure applied by the UE across the PUCCH resources of the TRPs.

In some such aspects, at least one of the TRPs transmits, prior to the receiving, a BFR procedure configuration specifying a process for the UE to choose BFR PUCCH resources for transmitting a BFR SR. In such aspects, receiving includes receiving the SR on BFR PUCCH resources chosen according to the transmitted BFR procedure configuration.

In some such aspects, at least one of the TRPs transmits, prior to the receiving, a common BFR PUCCH resource configuration for each BFR PUCCH resource of the UE wherein each BFR PUCCH resource comprises a different {periodicity, offset value} pair. In such aspects the receiving includes receiving a BFR SR on a particular BFR PUCCH resource under the transmitted common BFR PUCCH resource configuration with {periodicity, offset value} pair of the particular BFR PUCCH resource.

In some such aspects, at least one of the TRPs transmits, prior to the receiving, a different BFR PUCCH resource configuration for each BFR PUCCH resource of the UE. In such aspects, receiving includes receiving a BFR SR on a particular BFR PUCCH resource under the transmitted BFR PUCCH resource configuration of the particular BFR PUCCH resource.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating a base station and user equipment (UE) in an access network, in accordance with examples of the technology disclosed herein.

FIG. 4 is a diagram illustrating relationships between a UE and multiple transmit reception points (TRPs), for wireless communication.

FIG. 5 is a flowchart of methods of wireless communication in accordance with examples of the technology disclosed herein.

FIG. 6 is a flowchart of methods of wireless communication in accordance with examples of the technology disclosed herein.

FIG. 7 is a flowchart of methods of wireless communication in accordance with examples of the technology disclosed herein.

FIG. 8 is a flowchart of methods of wireless communication in accordance with examples of the technology disclosed herein.

FIG. 9 is a block diagram of a UE, in accordance with examples of the technology disclosed herein.

FIG. 10 is a flowchart of methods of wireless communication in accordance with examples of the technology disclosed herein.

FIG. 11 is a flowchart of methods of wireless communication in accordance with examples of the technology disclosed herein.

FIG. 12 is a flowchart of methods of wireless communication in accordance with examples of the technology disclosed herein.

FIG. 13 is a flowchart of methods of wireless communication in accordance with examples of the technology disclosed herein.

FIG. 14 is a block diagram of a UE, in accordance with examples of the technology disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

In some wireless communication networks, one or more base stations or cells can accommodate multiple transmission/reception point (TRPs) in communication with a single UE. For example, one or more BSs may coordinate to schedule a cluster of TRPs to serve a downlink transmission to a UE. Under beam failure detection and beam failure recovery in wireless communication networks, a dedicated reference signal from a base station to a UE is may be used by the UE for detecting a beam failure event. In uplink from the UE, e.g., in PUCCH, there may be a single set of resources to indicate a beam failure and request an uplink grant from the network to report specifics of the beam failure, e.g., using a BFR MAC-CE. With multi-TRP technology, the UE can detect a beam failure event specific to a TRP. But in cases with a single BFD/BFR procedure, and a single BFR scheduling request (SR) ID shared across multiple TRPs (multiple PUCCH resources foe BFR),

In aspects of the present disclosure, methods, non-transitory computer readable media, and apparatuses are provided. In some examples of the technology disclosed herein, a user equipment (UE) detects a beam failure associated with at least one transmission/reception point (TRP) of a plurality of TRPs transmitting to the UE Each TRP is associated with separate Physical Uplink Control Channel (PUCCH) resources for beam failure recovery (BFR). The UE applying, in response to the detecting, a BFR procedure across BFR PUCCH resources of the TRPs transmitting to the UE. In some aspects, the procedure is described by a single set of parameters/variable(s) across the PUCCH resources. Further, each of a plurality of TRPs transmits to a UE on a beam. A first of the TRPs receives, from the UE, a scheduling request (SR) in BFR PUCCH resources. The SR indicates that an uplink grant is requested by the UE to transmit beam failure information for at least one failed beam of the TRPs. The SR is a result of a single BFR procedure applied by the UE across the PUCCH resources of the TRPs.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

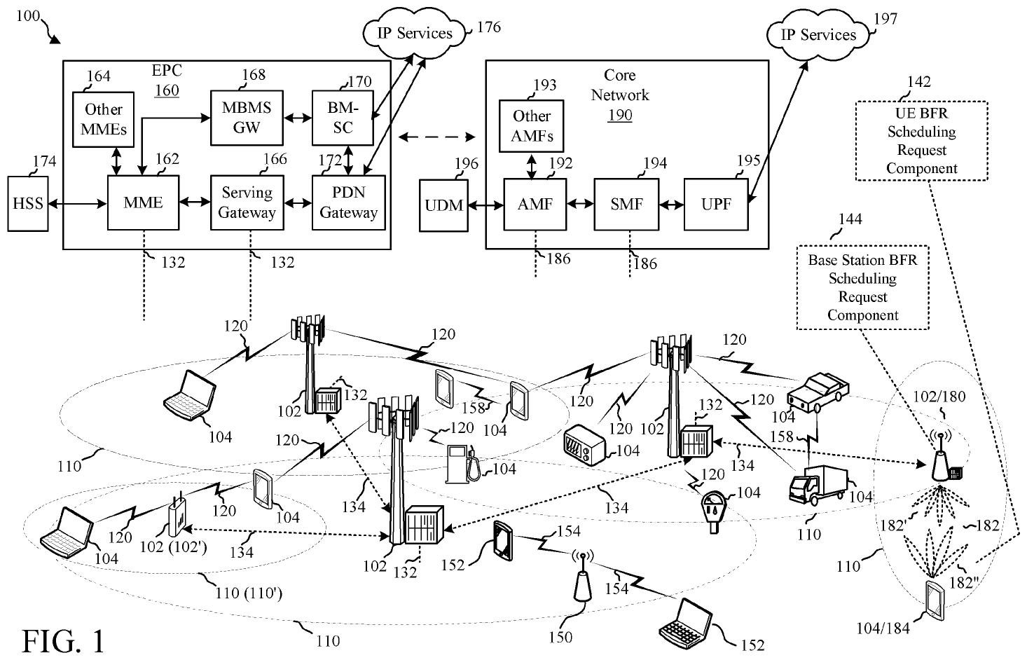

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells. The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 186. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first, second and third backhaul links 132, 186 and 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. In some examples of the technology disclosed herein, both the DL and the UL between the base station and a UE use the same set of multiple beams to transmit/receive physical channels. For example, a given set of beams can carry the multiple copies of a Physical Downlink Shared Channel (PDSCH), described further infra, on the DL, and can carry multiple copies of a Physical Uplink Control Channel (PUCCH), also described further infra, on the UL.

The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR. The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available. The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHZ and 30 GHZ, also referred to as centimeter wave. Communications using the mmW/near mmW radio frequency band (e.g., 3 GHZ-300 GHz) has extremely high path loss and a short range—making mmW transmissions susceptible to blocking and attenuation resulting in, e.g., unsuccessfully decoded data. The mmW base station 180 may utilize beamforming 182 with the UE 104/184 to compensate for the extremely high path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104/184 in one or more transmit directions 182′. The UE 104/184 may receive the beamformed signal from the base station 180 in one or more receive directions 182″. The UE 104/184 may also transmit a beamformed signal to the base station 180 in one or more transmit directions. The base station 180 may receive the beamformed signal from the UE 104 in one or more receive directions. The base station 180/UE 104/184 may perform beam training to determine the best receive and transmit directions for each of the base station 180/UE 104/184. The transmit and receive directions for the base station 180 may or may not be the same. The transmit and receive directions for the UE 104/184 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Continuing to refer to FIG. 1, in certain aspects, a UE detects a beam failure associated with at least one transmission/reception point (TRP) of a plurality of TRPs transmitting to the UE. Each TRP is associated with separate PUCCH resources for beam failure recovery (BFR). The UE applying, in response to the detecting, a BFR procedure across BFR PUCCH resources of the TRPs transmitting to the UE. In some aspects, the procedure is described by a single set of parameters/variable(s) across the PUCCH resources. Further, each of a plurality of TRPs transmits to a UE on a beam. A first of the TRPs receives, from the UE, a scheduling request (SR) in BFR PUCCH resources. The SR indicates that an uplink grant is requested by the UE to transmit beam failure information for at least one failed beam of the TRPs. The SR is a result of a single BFR procedure applied by the UE across the PUCCH resources of the TRPs.

Although the following description may be focused on 5G NR, the concepts described herein may be applicable to other similar areas, such as LTE, LTE-A, CDMA, GSM, and other wireless technologies.

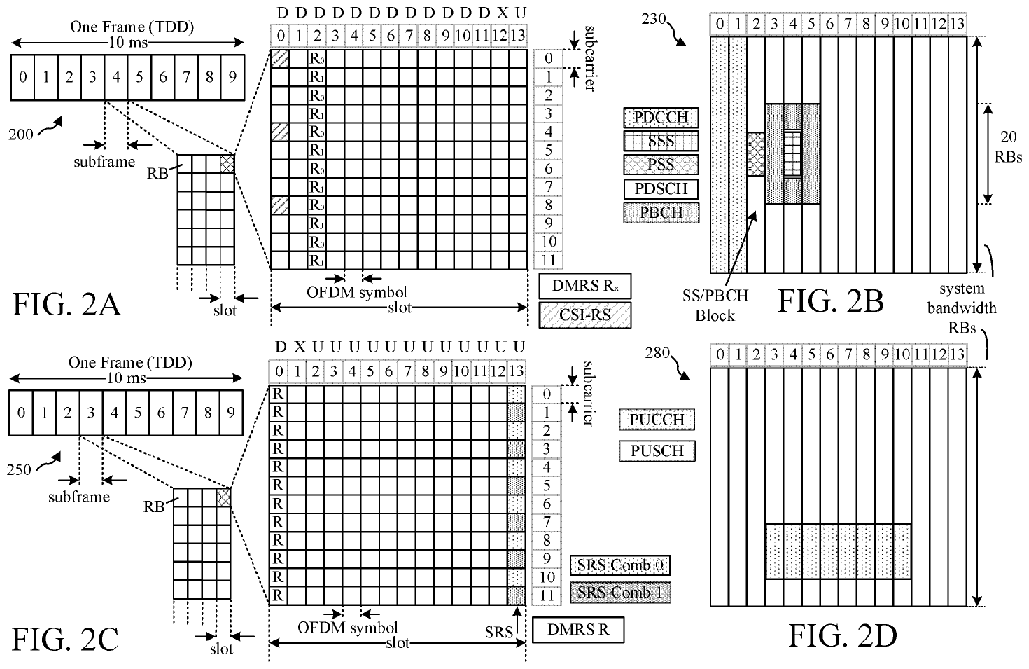

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 2^{μ}*15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS). Some examples of the technology disclosed herein use the DM-RS of the physical downlink control channel (PDCCH) to aid in channel estimation (and eventual demodulation of the user data portions) of the physical downlink shared channel (PDSCH).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests (SRs), a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

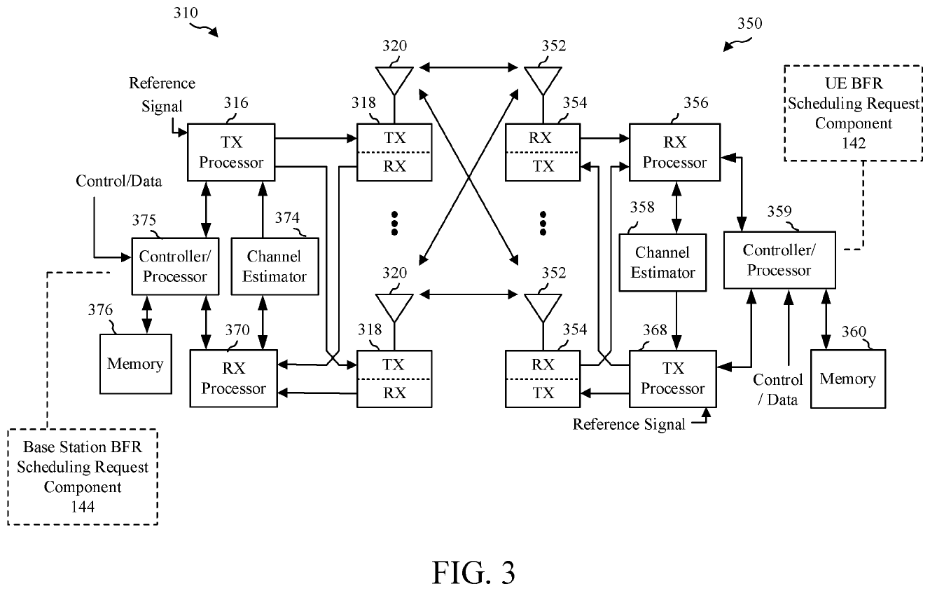

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and de-interleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

Continuing to refer to FIG. 3, and continuing to refer to prior figures for context, in certain aspects, a user equipment (UE) detects a beam failure associated with at least one transmission/reception point (TRP) of a plurality of TRPs transmitting to the UE. Each TRP is associated with separate Physical Uplink Control Channel (PUCCH) resources for beam failure recovery (BFR). The UE applying, in response to the detecting, a BFR procedure across BFR PUCCH resources of the TRPs transmitting to the UE. In some aspects, the procedure is described by a single set of parameters/variable(s) across the PUCCH resources. Further, each of a plurality of TRPs transmits to a UE on a beam. A first of the TRPs receives, from the UE, a scheduling request (SR) in BFR PUCCH resources. The SR indicates that an uplink grant is requested by the UE to transmit beam failure information for at least one failed beam of the TRPs. The SR is a result of a single BFR procedure applied by the UE across the PUCCH resources of the TRPs.

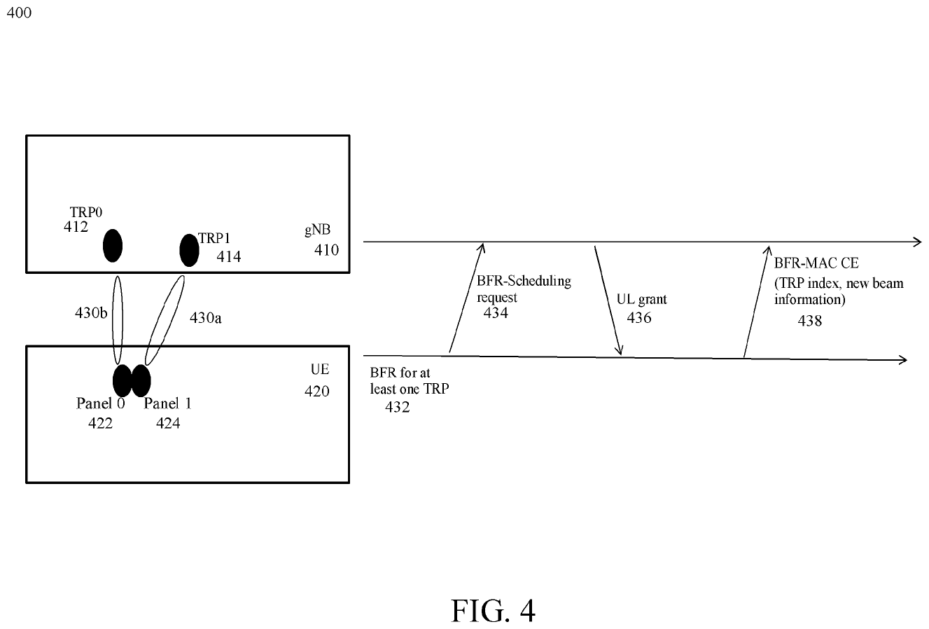

Referring to FIG. 4, and continuing to refer to prior figures for context, architectures 400 between a UE and multiple TRP (M-TRP), for wireless communication are illustrated. Future versions of 5G NR technology will support M-TRP at a single gNB, e.g., TRP0 412 and TRP1 414. Corresponding UEs, e.g., UE 420, may have multiple panels, e.g., Panel0 422 and Panel1 424—with each panel having a separate connecting beam. In FIG. 4, UE 420 Panel0 is connected to gNB TRP0 via beam 430b, and UE Panel1 is connected to TRP1 414 via beam 430a. In other examples, the TRPs correspond to different gNBs.

Previous methods of beam failure detection (BFD) and beam failure recovery are cell-specific, e.g., a beam failure event is defined in a cell-specific context. A UE may detect a beam failure event based on a beam failure detection reference signal (RS), and can indicate beam failure on a single set of beam failure detection resources in PUCCH in a cell-specific manner.

The UE 420 can use the BFD RS signal of each beam 430a, 430b to detect specific beam (and hence, specific TRP 412, 414 connection) failure 432. One or more beams from a plurality of TRPs to the UE 420 may fail—the example of FIG. 4 uses two TRPs 412, 414 for simplicity. Upon detection of a beam failure, the UE 420 can transmit a scheduling request (SR) 434 for BFR uplink resources to the gNB. After receiving the UL grant 436 from the gNB 410, the UE 420 can provide additional information to the gNB 410, e.g., via a BFR-MAC CE carrying TRP-Index and new beam information 438. In some example, the TRP-Index may be an ID of a CORESET pool index, an ID of BFD RS set, or any other ID reused for TRP-Index.

A UE configured with multiple BFR PUCCH-SR resources (and possibly sharing a single SR ID) will need a coordinated BFR procedure, including determining which BFR PUCCH resource to use for the SR and how to configure and apply such BFR procedure.

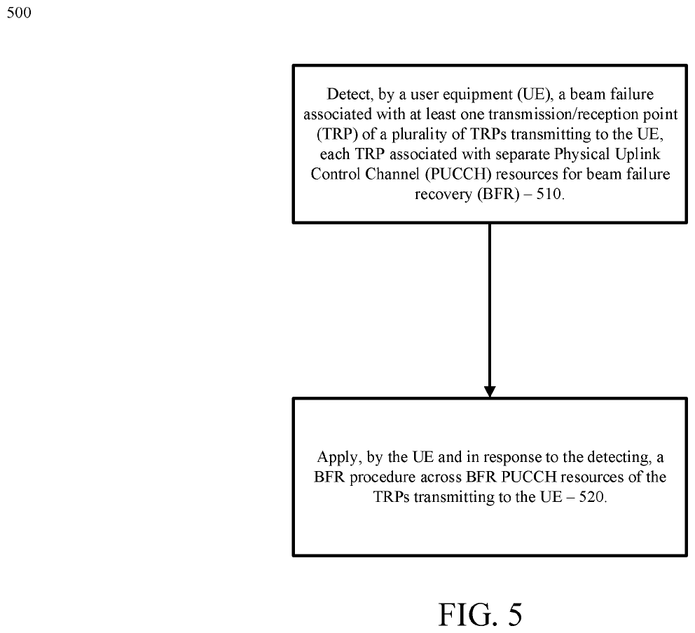

Referring to FIG. 5, and continuing to refer to prior figures for context, a flowchart of methods 500 of wireless communication is shown, in accordance with examples of the technology disclosed herein. In such methods 500, a UE detects a beam failure associated with at least one transmission/reception point (TRP) of a plurality of TRPs transmitting to the UE—Block 510. In such methods, each TRP is associated with a separate Physical Uplink Control Channel (PUCCH) resource for beam failure recovery (BFR). In the continuing example, UE 420 detects a beam failure associated with at least beam 430b associated with TRP0 412.

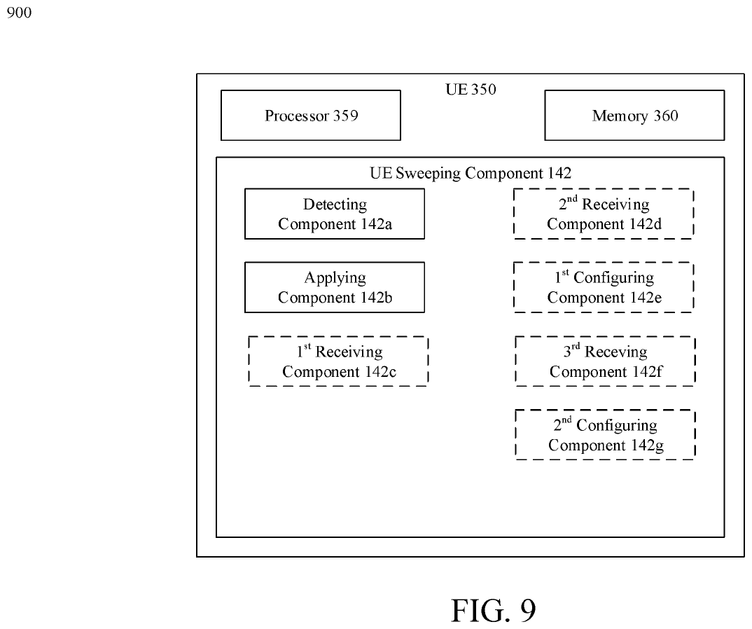

Referring to FIG. 9, and continuing to refer to prior figures for context, a UE 350 wireless communication device is shown, in accordance with examples of the technology disclosed herein. In addition to processor 359 and memory 360 described above in connection with FIG. 3, UE 350 includes UE BFR scheduling request (SR) component 142 as described in conjunction with FIG. 3 above. UE BFR SR component 142 includes detecting component 142a. In some examples, the detecting component 142a detects a beam failure associated with at least one transmission/reception point (TRP) of a plurality of TRPs transmitting to the UE. Accordingly, the detecting component 142a may provide means for detecting a beam failure associated with at least one transmission/reception point (TRP) of a plurality of TRPs transmitting to the UE.

Referring back to FIG. 5, the UE 184, applies, in response to the detecting, a BFR procedure across BFR PUCCH resources of the TRPs transmitting to the UE—Block 520. In the continuing example, the UE 184 the BFR procedure is parameterized by a single prohibit timer (e.g., sr-ProhibitTimer), a single maximum number of SR transmissions during a time (e.g., dsr-TransMax), a single identifier for scheduling requests from a UE (e.g., SchedulingRequestId) across the PUCCH resources and uses a single SR-COUNTER variable across the PUCCH resources.

In other examples, applying the BFR procedure includes transmitting a BFR scheduling request (SR) 434 on BFR PUCCH resources determined by the UE 420. In some examples, applying the BFR procedure comprises transmitting a BFR SR 434 on BFR PUCCH resources of a non-failed TRP, e.g., beam 430a between UE420 Panel1 424 and gNB TRP1 414. In some examples, applying the BFR procedure comprises transmitting a BFR SR 434 on BFR PUCCH resources based on higher layer instructions from the base station. The higher layer instructions may be indicated by RRC signaling, or MAC-CE signaling.

Referring to FIG. 9, and continuing to refer to prior figures for context, UE BFR SR component 142 includes applying component 142b. In some examples, the applying component 142b applies, in response to the detecting, a BFR procedure across PUCCH resources of the TRPs transmitting to the UE. Accordingly, the applying component 142b may provide means for applying, in response to the detecting, a BFR procedure across PUCCH resources of the TRPs transmitting to the UE.

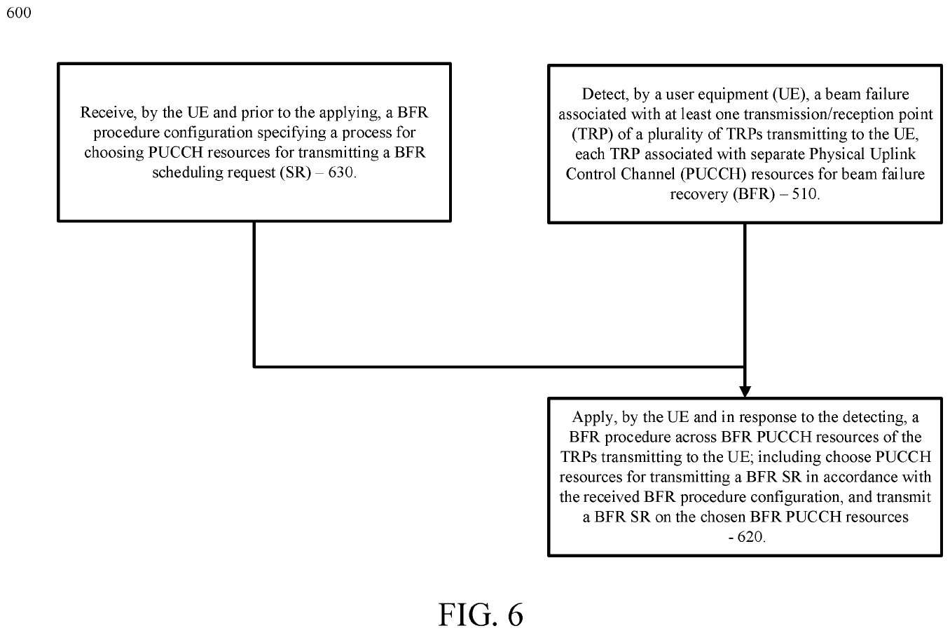

Referring to FIG. 6, and continuing to refer to prior figures for context, a flowchart of methods 600 of wireless communication is shown, in accordance with examples of the technology disclosed herein. In such methods 600, Block 510 is performed as described in connection with FIG. 5, and Block 520 is modified as described below in connection with Block 620.

In such methods 600, the UE receives, prior to the applying, a BFR procedure configuration specifying a process for choosing BFR PUCCH resources for transmitting a BFR scheduling request (SR)—Block 630. In the continuing example, the BFR procedure includes transmitting a BFR SR on BFR PUCCH resources most recently used by the UE for transmitting a BFR SR. In other examples, the BFR procedure comprises transmitting a BFR scheduling request (SR) on BFR PUCCH resources other than BFR PUCCH resources most recently used by the UE for transmitting a BFR SR.

Referring to FIG. 9, and continuing to refer to prior figures for context, UE BFR SR component 142 includes first receiving component 142c. In some examples, the first receiving component 142c receives, prior to the applying, a BFR procedure configuration specifying a process for choosing BFR PUCCH resources for transmitting a BFR SR. Accordingly, the first receiving component 142c may provide means for receiving, prior to the applying, a BFR procedure configuration specifying a process for choosing BFR PUCCH resources for transmitting a BFR SR.

Referring again to FIG. 6, in such methods 600, applying the BFR procedure includes choosing BFR PUCCH resources for transmitting a BFR SR in accordance with the received BFR procedure configuration, and transmitting a BFR SR on the chosen BFR PUCCH resource—Block 620. In the continuing example, applying the BFR procedure includes transmitting a BFR SR on BFR PUCCH resources most recently used by the UE for transmitting a BFR SR. Sticking with the same beam may allow the gNB to better train the reception. In other examples, applying the BFR procedure comprises transmitting a BFR scheduling request (SR) on BFR PUCCH resources other than BFR PUCCH resources most recently used by the UE for transmitting a BFR SR—possibly providing beam diversity that can be useful in overcoming interference.

Referring to FIG. 9, in such methods, applying component 142b applies, in response to the detecting, a BFR procedure across PUCCH resources of the TRPs transmitting to the UE, including choosing BFR PUCCH resources for transmitting a BFR SR in accordance with the received BFR procedure configuration, and transmitting a BFR SR on the chosen BFR PUCCH resource. Accordingly, the applying component 142b may provide means for applying, in response to the detecting, a BFR procedure across PUCCH resources of the TRPs transmitting to the UE including choosing BFR PUCCH resources for transmitting a BFR SR in accordance with the received BFR procedure configuration, and transmitting a BFR SR on the chosen BFR PUCCH resource.

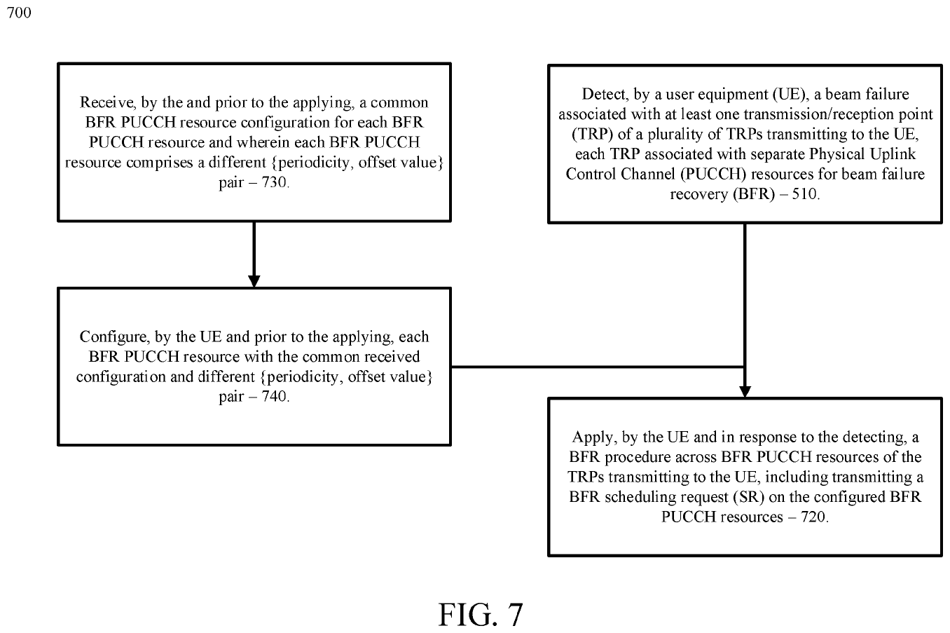

Referring to FIG. 7, and continuing to refer to prior figures for context, a flowchart of methods 700 of wireless communication is shown, in accordance with examples of the technology disclosed herein. In such methods 700, Block 510 is performed as described in connection with FIG. 5, and Block 520 is modified as described below in connection with Block 720.

In such methods 700, the UE receives, prior to the applying, a common BFR PUCCH resource configuration for each BFR PUCCH resource and wherein each BFR PUCCH resource comprises a different {periodicity, offset value} pair—Block 730. In the continuing example, the SchedulingRequestResourceConfig of TABLE1 is used, the same time domain and frequency domain allocations, but different periodicity and different offset value. For example, the first BFR PUCCH resource is associated with the {periodicity, offset value} pair indicated by a parameter of periodicity AndOffset1, and the second BFR PUCCH resource is associated with the {periodicity, offset value} pair indicated by a parameter of periodicity AndOffset2, and the two BFR PUCCH resources are associated with a same schedulingRequestID.

TABLE 1

```
SchedulingRequestResourceConfig ::= SEQUENCE {
  schedulingRequestResourceId SchedulingRequestResourceId,
  schedulingRequestID SchedulingRequestId,
  periodicityAndOffset1
  periodicityAndOffset2
  BFR-resource PUCCH-ResourceId
}
```

Referring to FIG. 9, and continuing to refer to prior figures for context, UE BFR SR component 142 includes second receiving component 142d. In some examples, the second receiving component 142d receives, prior to the applying, a common BFR PUCCH resource configuration for each BFR PUCCH resource and wherein each BFR PUCCH resource comprises a different {periodicity, offset value} pair. Accordingly, the second receiving component 142d may provide means for receiving, prior to the applying, a common BFR PUCCH resource configuration for each BFR PUCCH resource and wherein each BFR PUCCH resource comprises a different {periodicity, offset value} pair.

Referring again to FIG. 7, the UE then configures, prior to the applying, each BFR PUCCH resource with the common received configuration and different {periodicity, offset value} pair—Block 740.

Referring to FIG. 9, and continuing to refer to prior figures for context, UE BFR SR component 142 includes first configuring component 142e. In some examples, the first configuring component 142e configures, prior to the applying, each BFR PUCCH resource with the common received configuration and different {periodicity, offset value} pair. Accordingly, the first configuring component 142e may provide means for configuring, prior to the applying, each BFR PUCCH resource with the common received configuration and different {periodicity, offset value} pair.

In such methods, applying the BFR procedure comprises transmitting a BFR scheduling request (SR) on the configured BFR PUCCH resources—Block 720.

Referring to FIG. 9, in such methods, applying component 142b applies, in response to the detecting, a BFR procedure across PUCCH resources of the TRPs transmitting to the UE, including applying the BFR procedure comprises transmitting a BFR scheduling request (SR) on the configured BFR PUCCH resources. Accordingly, the applying component 142b may provide means for applying, in response to the detecting, a BFR procedure across PUCCH resources of the TRPs transmitting to the UE including applying the BFR procedure comprises transmitting a BFR scheduling request (SR) on the configured BFR PUCCH resources.

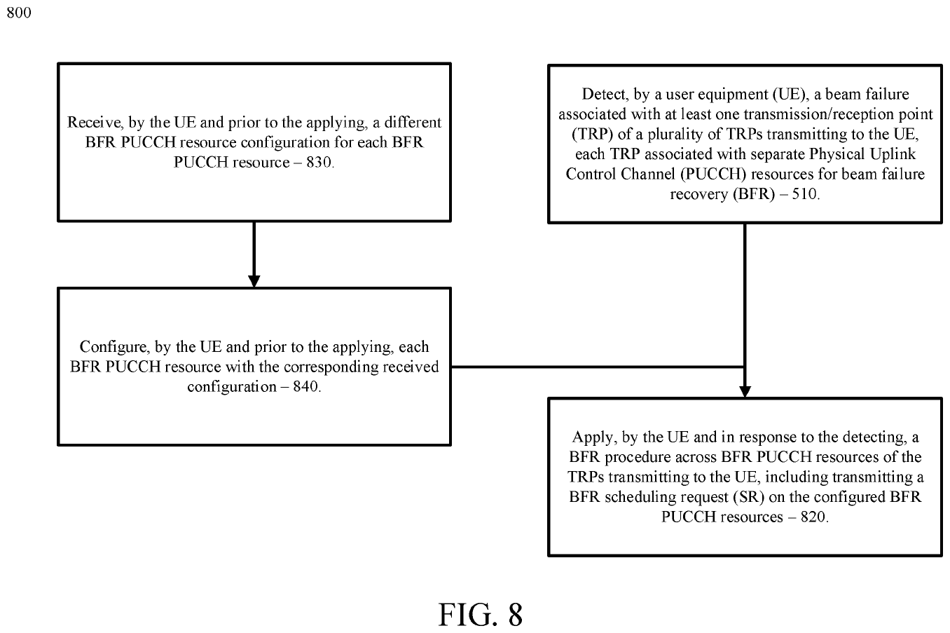

Referring to FIG. 8, and continuing to refer to prior figures for context, a flowchart of methods 800 of wireless communication is shown, in accordance with examples of the technology disclosed herein. In such methods 800, Block 510 is performed as described in connection with FIG. 5, and Block 520 is modified as described below in connection with Block 820.

In such methods 800, the UE receives, prior to the applying, a different BFR PUCCH resource configuration for each BFR PUCCH resource—Block 830. In a separate example, the SchedulingRequestResourceConfig of TABLE2 is used. For example, the first BFR PUCCH resource is indicated by a first PUCCH Resource ID, and the second BFR PUCCH resource is indicated by a second PUCCH Resource ID, and the two BFR PUCCH resources are associated with a same schedulingRequestID.

TABLE 2

```
SchedulingRequestResourceConfig ::= SEQUENCE {
  schedulingRequestResourceId SchedulingRequestResourceId,
  schedulingRequestID SchedulingRequestId,
  periodicityAndOffset CHOICE {
    sym2 NULL,
    sym6or7 NULL,
    ...
  }
  BFR-resource1 PUCCH-ResourceId
  BFR-resource2 PUCCH-ResourceId
}
```

Referring to FIG. 9, and continuing to refer to prior figures for context, UE BFR SR component 142 includes third receiving component 142f. In some examples, the third receiving component 142f receives, prior to the applying, a different BFR PUCCH resource configuration for each BFR PUCCH resource. Accordingly, the second receiving component 142f may provide means for receiving, prior to the applying, a different BFR PUCCH resource configuration for each BFR PUCCH resource.

In such methods 800, the UE then configures, prior to the applying, each BFR PUCCH resource with the corresponding received configuration—Block 840.

Referring to FIG. 9, and continuing to refer to prior figures for context, UE BFR SR component 142 includes second configuring component 142g. In some examples, the second configuring component 142g configures, prior to the applying, each BFR PUCCH resource with the corresponding received configuration. Accordingly, the second configuring component 142g may provide means for configuring, prior to the applying, each BFR PUCCH resource with the corresponding received configuration.

In such methods, applying the BFR procedure comprises transmitting a BFR scheduling request (SR) on the configured BFR PUCCH resources—Block 820.

Referring to FIG. 9, in such methods, applying component 142b applies, in response to the detecting, a BFR procedure across PUCCH resources of the TRPs transmitting to the UE, including applying the BFR procedure comprises transmitting a BFR scheduling request (SR) on the configured BFR PUCCH resources. Accordingly, the applying component 142b may provide means for applying, in response to the detecting, a BFR procedure across PUCCH resources of the TRPs transmitting to the UE including applying the BFR procedure comprises transmitting a BFR scheduling request (SR) on the configured BFR PUCCH resources.

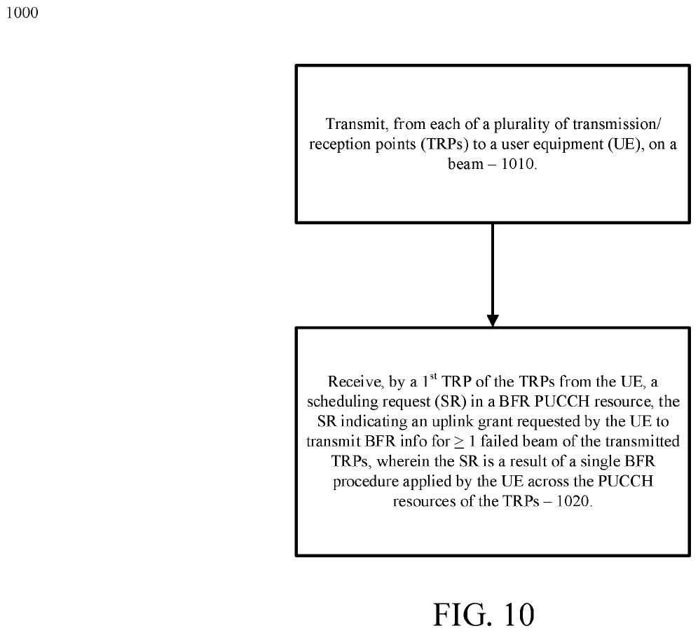

Referring to FIG. 10, and continuing to refer to prior figures for context, a flowchart of methods 1000 of wireless communication is shown, in accordance with examples of the technology disclosed herein. In such methods, the each of a plurality of transmission/reception points (TRPs) transmits to a UE on a beam—Block 1010.

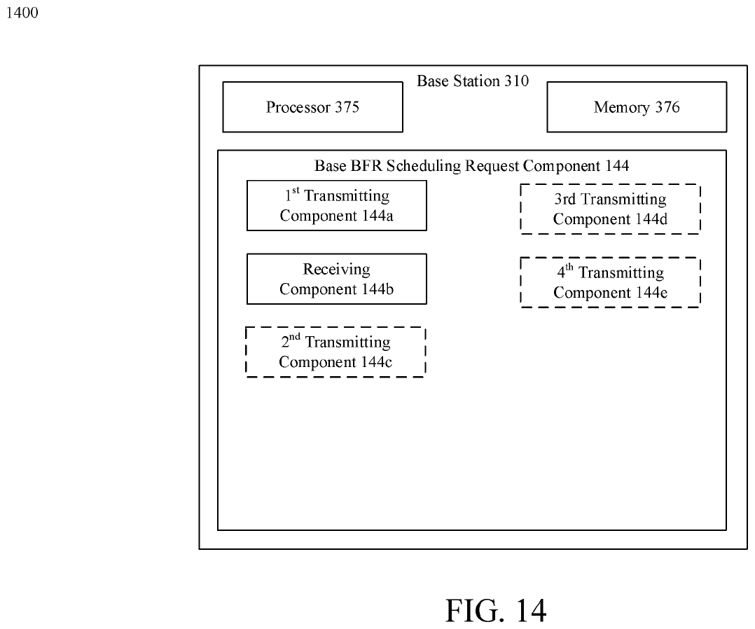

Referring to FIG. 14, and continuing to refer to prior figures for context, a base station 310 wireless communication device is shown, in accordance with examples of the technology disclosed herein. In addition to processor 375 and memory 376, base station 310 includes base station UE BFR scheduling request (SR) component 144 as described in conjunction with FIG. 3 above. Base station BFR SR component 144 includes transmitting component 144a. In some examples, the transmitting component 144a transmits from each of a plurality of TRPs to a UE. Accordingly, the transmitting component 144a may provide means for transmitting from each of a plurality of TRPs to a UE.

Referring again to FIG. 10, a first TRP of the TRPs receives, from the UE, a scheduling request (SR) in a beam failure recovery (BRF) physical uplink control channel (PUCCH) resource—Block 1020. In such methods 1000, the SR indicates that an uplink grant is requested by the UE to transmit beam failure information for at least one failed beam of the transmitted TRPs, and the received SR is a result of a single BFR procedure applied by the UE across the PUCCH resources of the TRPs.

Referring to FIG. 14, base station BFR SR component 144 includes receiving component 144b. In some examples, in receiving component 144b a first TRP of the TRPs receives, from the UE, a scheduling request (SR) in a beam failure recovery (BRF) physical uplink control channel (PUCCH) resource. Accordingly, the receiving component 144b may provide means for a first TRP of the TRPs receiving, from the UE, a scheduling request (SR) in a beam failure recovery (BRF) physical uplink control channel (PUCCH) resource.

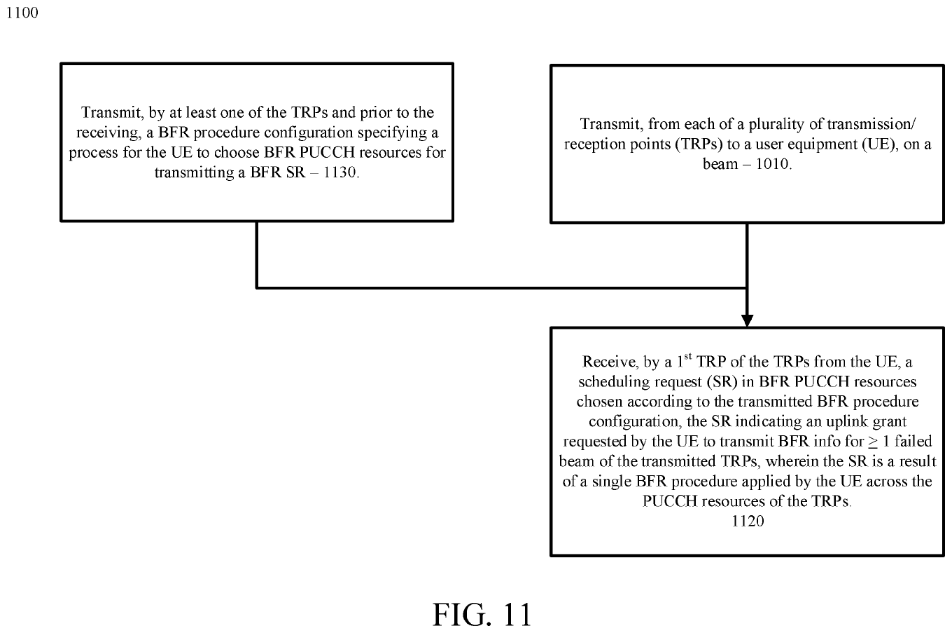

Referring to FIG. 11, and continuing to refer to prior figures for context, a flowchart of methods 1100 of wireless communication is shown, in accordance with examples of the technology disclosed herein. In such methods 1100, Block 1010 is performed as described in connection with FIG. 10, and Block 1020 is modified as described below in connection with Block 1120.

In such methods 1100, at least one of the TRPs transmits, prior to the receiving, a BFR procedure configuration specifying a process for the UE to choose BFR PUCCH resources for transmitting a BFR SR—Block 1130.

Referring to FIG. 14, and base station BFR SR component 144 includes second component transmitting 144c. In some examples, in second transmitting component 144c at least one of the TRPs transmits, prior to the receiving, a BFR procedure configuration specifying a process for the UE to choose BFR PUCCH resources for transmitting a BFR SR. Accordingly, the second transmitting component 144c may provide means for at least one of the TRPs transmitting, prior to the receiving, a BFR procedure configuration specifying a process for the UE to choose BFR PUCCH resources for transmitting a BFR SR.

In such methods 1100, receiving comprises receiving the SR on BFR PUCCH resources chosen according to the transmitted BFR procedure configuration—Block 1120.

Referring to FIG. 14, in such methods, base station BFR SR component 144 includes receiving component 144b. In some examples, in receiving component 144b a first TRP of the TRPs receives, from the UE, a scheduling request (SR) in a beam failure recovery (BRF) physical uplink control channel (PUCCH) resource, including receiving the SR on BFR PUCCH resources chosen according to the transmitted BFR procedure configuration. Accordingly, the receiving component 144b may provide means for a first TRP of the TRPs receiving, from the UE, a scheduling request (SR) in a beam failure recovery (BRF) physical uplink control channel (PUCCH) resource, including receiving the SR on BFR PUCCH resources chosen according to the transmitted BFR procedure configuration.

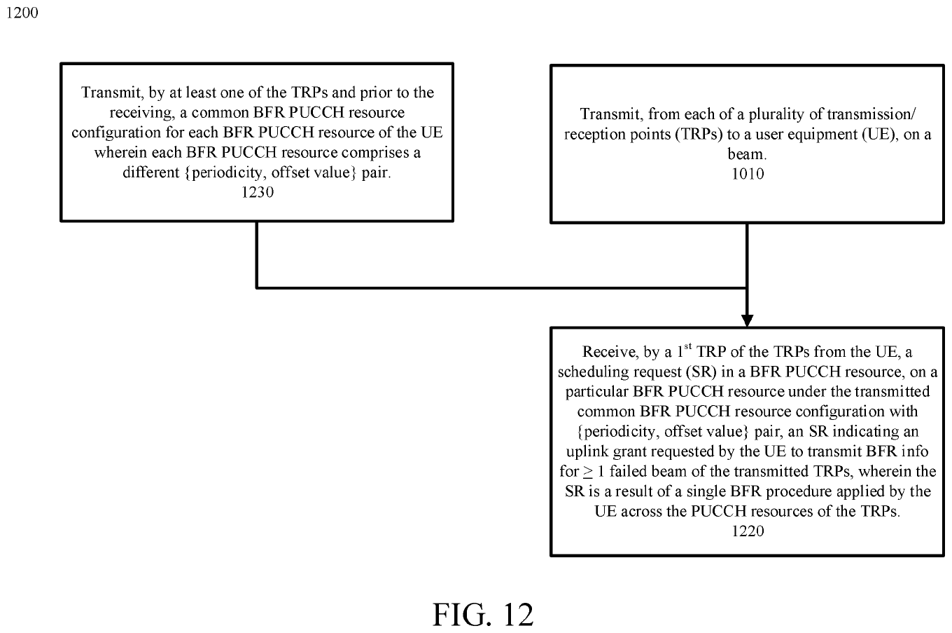

Referring to FIG. 12, and continuing to refer to prior figures for context, a flowchart of methods 1200 of wireless communication is shown, in accordance with examples of the technology disclosed herein. In such methods 1200, Block 1010 is performed as described in connection with FIG. 10, and Block 1020 is modified as described below in connection with Block 1220.

In such methods 1200, at least one of the TRPs transmits, prior to the receiving, a common BFR PUCCH resource configuration for each BFR PUCCH resource of the UE wherein each BFR PUCCH resource comprises a different {periodicity, offset value} pair-Block 1230.

Referring to FIG. 14, and base station BFR SR component 144 includes third transmitting component 144d. In some examples, in third transmitting component 144d at least one of the TRPs transmits, prior to the receiving, a common BFR PUCCH resource configuration for each BFR PUCCH resource of the UE wherein each BFR PUCCH resource comprises a different {periodicity, offset value} pair. Accordingly, the third transmitting component 144d may provide means for at least one of the TRPs transmitting, prior to the receiving, a common BFR PUCCH resource configuration for each BFR PUCCH resource of the UE wherein each BFR PUCCH resource comprises a different {periodicity, offset value} pair.

In such methods 1200, the receiving comprises receiving a BFR SR on a particular BFR PUCCH resource under the transmitted common BFR PUCCH resource configuration with {periodicity, offset value} pair of the particular BFR PUCCH resource-Block 1220.

Referring to FIG. 14, in such methods, base station BFR SR component 144 includes receiving component 144b. In some examples, in receiving component 144b a first TRP of the TRPs receives, from the UE, a scheduling request (SR) in a beam failure recovery (BRF) physical uplink control channel (PUCCH) resource, including receiving a BFR SR on a particular BFR PUCCH resource under the transmitted common BFR PUCCH resource configuration with {periodicity, offset value} pair of the particular BFR PUCCH resource. Accordingly, the receiving component 144b may provide means for a first TRP of the TRPs receiving, from the UE, a scheduling request (SR) in a beam failure recovery (BRF) physical uplink control channel (PUCCH) resource, including receiving a BFR SR on a particular BFR PUCCH resource under the transmitted common BFR PUCCH resource configuration with {periodicity, offset value} pair of the particular BFR PUCCH resource.

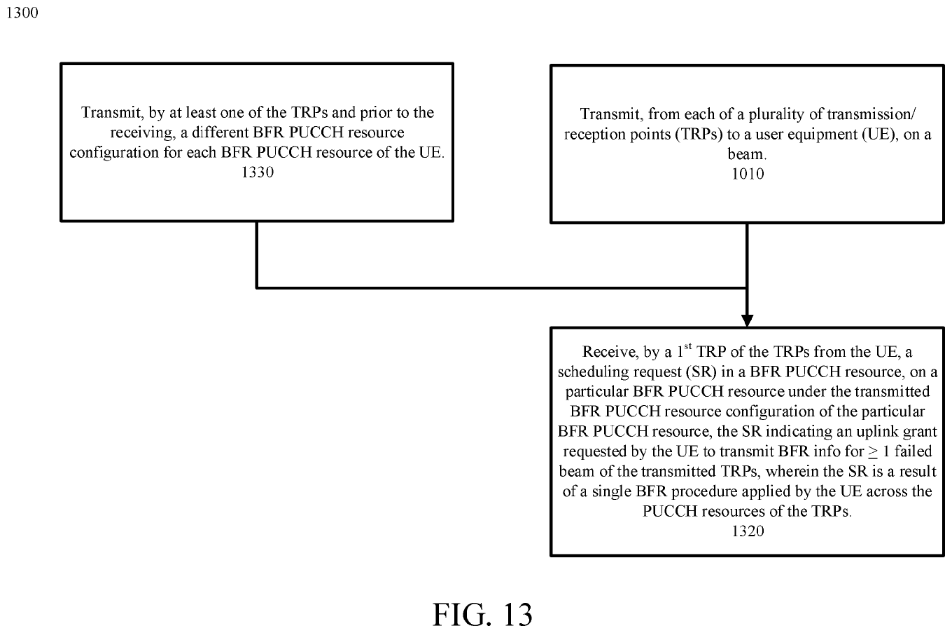

Referring to FIG. 13, and continuing to refer to prior figures for context, a flowchart of methods 1300 of wireless communication is shown, in accordance with examples of the technology disclosed herein. In such methods 1300, Block 1010 is performed as described in connection with FIG. 10, and Block 1020 is modified as described below in connection with Block 1320.

In such methods 1300, at least one of the TRPs transmits, prior to the receiving, a different BFR PUCCH resource configuration for each BFR PUCCH resource of the UE-Block 1330.

Referring to FIG. 14, and base station BFR SR component 144 includes fourth transmitting component 144e. In some examples, in fourth transmitting component 144e at least one of the TRPs transmits, prior to the receiving, a different BFR PUCCH resource configuration for each BFR PUCCH resource of the UE. Accordingly, the fourth transmitting component 144e may provide means for at least one of the TRPs transmitting, prior to the receiving, a different BFR PUCCH resource configuration for each BFR PUCCH resource of the UE.

In such methods 1300, the receiving comprises receiving a BFR SR on a particular BFR PUCCH resource under the transmitted BFR PUCCH resource configuration of the particular BFR PUCCH resource—Block 1320.

Referring to FIG. 14, in such methods, base station BFR SR component 144 includes receiving component 144b. In some examples, in receiving component 144b a first TRP of the TRPs receives, from the UE, a scheduling request (SR) in a beam failure recovery (BRF) physical uplink control channel (PUCCH) resource, including receiving a BFR SR on a particular BFR PUCCH resource under the transmitted BFR PUCCH resource configuration of the particular BFR PUCCH resource. Accordingly, the receiving component 144b may provide means for a first TRP of the TRPs receiving, from the UE, a scheduling request (SR) in a beam failure recovery (BRF) physical uplink control channel (PUCCH) resource, including receiving a BFR SR on a particular BFR PUCCH resource under the transmitted BFR PUCCH resource configuration of the particular BFR PUCCH resource.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The following examples are illustrative only and aspects thereof may be combined with aspects of other embodiments or teaching described herein, without limitation.

Example 1 includes methods and apparatuses (including those comprising means for performing the methods) for beam failure recovery in wireless communication systems employing multiple transmission/reception points. In Example 1, a user equipment (UE) detects beam failure associated with a transmission/reception point (TRP) of a plurality of TRPs transmitting to the UE. Each TRP is associated with separate Physical Uplink Control Channel (PUCCH) resources for beam failure recovery (BFR). The UE applies, in response to detecting, a BFR procedure across PUCCH resources of the TRPs. In some aspects, the procedure is described by a single set of parameters/variable(s) across the PUCCH resources.

In Example 2, Example 1 further includes that the BFR procedure is parameterized by a single sr-ProhibitTimer, a single dsr-TransMax, a single SchedulingRequestId across the PUCCH resources, and the BFR procedure uses a single SR-COUNTER variable across the PUCCH resources. In Example 3, any of Example 1 and Example 2 includes applying the BFR procedure to include transmitting a BFR scheduling request (SR) on BFR PUCCH resources determined by the UE. In Example 4, any of Examples 1-3 includes applying the BFR procedure to include transmitting a BFR scheduling request (SR) on BFR PUCCH resources of a non-failed TRP. In Example 5, any of Examples 1-4 includes the UE receiving, prior to the applying, a BFR procedure configuration specifying a process for choosing BFR PUCCH resources for transmitting a BFR scheduling request (SR). In such examples, applying the BFR procedure includes choosing BFR PUCCH resources for transmitting a BFR SR in accordance with the received BFR procedure configuration, and transmitting a BFR SR on the chosen BFR PUCCH resource. In Example 6, any of Examples 1-5 includes applying the BFR procedure to include transmitting a BFR scheduling request (SR) on BFR PUCCH resources most recently used by the UE for transmitting a BFR SR. In Example 7, any of Examples 1-6 includes applying the BFR procedure to include transmitting a BFR scheduling request (SR) on BFR PUCCH resources other than BFR PUCCH resources most recently used by the UE for transmitting a BFR SR. In Example 8, any of Examples 1-7 includes the UE receiving, prior to the applying, a common BFR PUCCH resource configuration for each BFR PUCCH resource and wherein each BFR PUCCH resource comprises a different {periodicity, offset value} pair. In such examples, the UE configures, prior to the applying, each BFR PUCCH resource with the common received configuration and different {periodicity, offset value} pair. In such examples, applying the BFR procedure includes transmitting a BFR scheduling request (SR) on a configured BFR PUCCH resource. In Example 9, any of the Examples 1-8 includes the UE receiving, prior to the applying, a different BFR PUCCH resource configuration for each BFR PUCCH resource. In such examples, the UE configures, prior to the applying, each BFR PUCCH resource with the corresponding received configuration. In such examples, applying the BFR procedure includes transmitting a BFR scheduling request (SR) on a configured BFR PUCCH resource.

Example 10 includes methods and apparatuses (including those comprising means for performing the methods) for beam failure recovery in wireless communication systems employing multiple transmission/reception points. In Example 10, each of a plurality of TRPs transmits to a UE on a beam. A first of the TRPs receives, from the UE, a scheduling request (SR) in BFR PUCCH resources. The SR indicates that an uplink grant is requested by the UE to transmit beam failure information for at least one failed beam of the TRPs. The SR is a result of a single BFR procedure applied by the UE across the PUCCH resources of the TRPs. In Example 11, Example 10 further includes at least one of the TRPs transmitting, prior to the receiving, a BFR procedure configuration specifying a process for the UE to choose BFR PUCCH resources for transmitting a BFR SR. In such examples, receiving includes receiving the SR on BFR PUCCH resources chosen according to the transmitted BFR procedure configuration. In example 12, any of Examples 10-11 includes at least one of the TRPs transmitting, prior to the receiving, a common BFR PUCCH resource configuration for each BFR PUCCH resource of the UE wherein each BFR PUCCH resource comprises a different {periodicity, offset value} pair. In such examples, the receiving includes receiving a BFR SR on a particular BFR PUCCH resource under the transmitted common BFR PUCCH resource configuration with {periodicity, offset value} pair of the particular BFR PUCCH resource. In Example 13, any of Examples 10-12 includes at least one of the TRPs transmitting, prior to the receiving, a different BFR PUCCH resource configuration for each BFR PUCCH resource of the UE. In such aspects, receiving includes receiving a BFR SR on a particular BFR PUCCH resource under the transmitted BFR PUCCH resource configuration of the particular BFR PUCCH resource.

Example 14 includes a computer-readable medium storing computer executable code, the code when executed by a processor cause the processor to execute the method of any one or more of claims 1-13.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication, comprising:
detecting, by a user equipment (UE), a beam failure associated with at least one transmission/reception point (TRP) of a plurality of TRPs transmitting to the UE, each TRP associated with separate Physical Uplink Control Channel (PUCCH) resources for beam failure recovery (BFR); and
applying, by the UE and in response to the detecting, a BFR procedure across BFR PUCCH resources of the TRPs transmitting to the UE.

2. The method of claim 1, wherein:
the BFR procedure is parameterized by a single sr-ProhibitTimer, a single dsr-TransMax, a single SchedulingRequestId across the PUCCH resources, and
the BFR procedure uses a single SR-COUNTER variable across the BFR PUCCH resources.

3. The method of claim 2, wherein applying the BFR procedure comprises transmitting a BFR scheduling request (SR) on PUCCH resources determined by the UE.

4. The method of claim 2, wherein applying the BFR procedure comprises transmitting a BFR scheduling request (SR) on PUCCH resources of a non-failed TRP.

5. The method of claim 2:
further comprising receiving, by the UE and prior to the applying, a BFR procedure configuration specifying a process for choosing PUCCH resources for transmitting a BFR scheduling request (SR),
wherein applying the BFR procedure comprises:
choosing PUCCH resources for transmitting a BFR SR in accordance with the received BFR procedure configuration; and
transmitting a BFR SR on the chosen PUCCH resources.

6. The method of claim 2, wherein applying the BFR procedure comprises transmitting a BFR scheduling request (SR) on PUCCH resources most recently used by the UE for transmitting a BFR SR.

7. The method of claim 2, wherein applying the BFR procedure comprises transmitting a BFR scheduling request (SR) on PUCCH resources other than PUCCH resources most recently used by the UE for transmitting a BFR SR.

8. The method of claim 2, further comprising:
receiving, by the UE and prior to the applying, a common PUCCH resource configuration for each BFR PUCCH resource and wherein each BFR PUCCH resource comprises a different {periodicity, offset value} pair; and
configuring, by the UE and prior to the applying, each BFR PUCCH resource with the common received configuration and different {periodicity, offset value} pair, wherein applying the BFR procedure comprises transmitting a BFR scheduling request (SR) on the configured BFR PUCCH resources.

9. The method of claim 2, further comprising:
receiving, by the UE and prior to the applying, a different BFR PUCCH resource configuration for each BFR PUCCH resource; and
configuring, by the UE and prior to the applying, each BFR PUCCH resource with the corresponding received configuration,
wherein applying the BFR procedure comprises transmitting a BFR scheduling request (SR) on the configured BFR PUCCH resources.

10. An apparatus for wireless communication, comprising:
a memory; and
at least one processor coupled to the memory, the memory including instructions executable by the at least one processor to cause the apparatus to:
detect a beam failure associated with at least one transmission/reception point (TRP) of a plurality of TRPs transmitting to the UE, each TRP associated with separate Physical Uplink Control Channel (PUCCH) resources for beam failure recovery (BFR); and
apply, in response to the detecting, a BFR procedure across BFR PUCCH resources of the TRPs transmitting to the UE.

11. The apparatus of claim 10, wherein:
the BFR procedure is parameterized by a single sr-ProhibitTimer, a single dsr-TransMax, a single SchedulingRequestId across the PUCCH resources, and
the BFR procedure uses a single SR-COUNTER variable across the PUCCH resources.

12. The apparatus of claim 11, wherein applying the BFR procedure comprises transmitting a BFR scheduling request (SR) on BFR PUCCH resources determined by the apparatus.

13. The apparatus of claim 11, wherein applying the BFR procedure comprises transmitting a BFR scheduling request (SR) on BFR PUCCH resources of a non-failed TRP.

14. The apparatus of claim 11, wherein the memory further includes instructions executable by the at least one processor to cause the apparatus to:
receive, prior to the applying, a BFR procedure configuration specifying a process for choosing BFR PUCCH resources for transmitting a BFR scheduling request (SR),
wherein applying the BFR procedure comprises:
choosing PUCCH resources for transmitting a BFR SR in accordance with the received BFR procedure configuration; and
transmitting a BFR SR on the chosen BFR PUCCH resources.

15. The apparatus of claim 11, wherein applying the BFR procedure comprises transmitting a BFR scheduling request (SR) on BFR PUCCH resources most recently used by the apparatus for transmitting a BFR SR.

16. The apparatus of claim 11, wherein applying the BFR procedure comprises transmitting a BFR scheduling request (SR) on BFR PUCCH resources other than BFR PUCCH resources most recently used by the apparatus for transmitting a BFR SR.

17. The apparatus of claim 11, wherein the memory further includes instructions executable by the at least one processor to cause the apparatus to:
receive, prior to the applying, a common BFR PUCCH resource configuration for each BFR PUCCH resource and wherein each BFR PUCCH resource configuration comprises a different {periodicity, offset value} pair; and
configure, prior to the applying, each BFR PUCCH resource with the common received configuration and different {periodicity, offset value} pair,
wherein applying the BFR procedure comprises transmitting a BFR scheduling request (SR) on the configured BFR PUCCH resources.

18. The apparatus of claim 11, wherein the memory further includes instructions executable by the at least one processor to cause the apparatus to:
receive, prior to the applying, a different BFR PUCCH resource configuration for each BFR PUCCH resource; and
configure, prior to the applying, each BFR PUCCH resource with the corresponding received configuration,
wherein applying the BFR procedure comprises transmitting a BFR scheduling request (SR) on the configured BFR PUCCH resources.

19.-36. (canceled)

37. A method of wireless communication, comprising:
transmitting, from each of a plurality of transmission/reception points (TRPs) to a UE, on a beam; and
receiving, by a first TRP of the TRPs and from the UE, a scheduling request (SR) in a beam failure recovery (BRF) physical uplink control channel (PUCCH) resource, the SR indicating that a uplink grant is requested by the UE to transmit beam failure information for at least one failed beam of the transmitted TRPs,
wherein, the received SR is a result of a single BFR procedure applied by the UE across the PUCCH resources of the TRPs.

38. The method of claim 37:
further comprising transmitting, by at least one of the TRPs and prior to the receiving, a BFR procedure configuration specifying a process for the UE to choose BFR PUCCH resources for transmitting a BFR SR,
wherein receiving comprises receiving the SR on BFR PUCCH resources chosen according to the transmitted BFR procedure configuration.

39. The method of claim 37:
further comprising transmitting, by at least one of the TRPs and prior to the receiving, a common BFR PUCCH resource configuration for each BFR PUCCH resource of the UE wherein each BFR PUCCH resource comprises a different {periodicity, offset value} pair,
wherein the receiving comprises receiving a BFR SR on a particular BFR PUCCH resource under the transmitted common BFR PUCCH resource configuration with {periodicity, offset value} pair of the particular BFR PUCCH resource.

40. The method of claim 37:
further comprising transmitting, by at least one of the TRPs and prior to the receiving, a different BFR PUCCH resource configuration for each BFR PUCCH resource of the UE,
wherein the receiving comprises receiving a BFR SR on a particular BFR PUCCH resource under the transmitted BFR PUCCH resource configuration of the particular BFR PUCCH resource.

41. An apparatus for wireless communication, comprising:
a memory; and
at least one processor coupled to the memory, the memory including instructions executable by the at least one processor to cause the apparatus to:
transmit, from each of a plurality of transmission/reception points (TRPs) to a UE, on a beam; and
receive, by a first TRP of the TRPs and from the UE, a scheduling request (SR) in a beam failure recovery (BRF) physical uplink control channel (PUCCH) resource, the SR indicating that a uplink grant is requested by the UE to transmit beam failure information for at least one failed beam of the transmitted TRPs,
wherein, the received SR is a result of a single BFR procedure applied by the UE across the PUCCH resources of the TRPs.

42. The apparatus of claim 41, wherein the memory further includes instructions executable by the at least one processor to cause the apparatus to:
transmit, by at least one of the TRPs and prior to the receiving, a BFR procedure configuration specifying a process for the UE to choose BFR PUCCH resources for transmitting a BFR SR,
wherein receiving comprises receiving the SR on BFR PUCCH resources chosen according to the transmitted BFR procedure configuration.

43. The apparatus of claim 41, wherein the memory further includes instructions executable by the at least one processor to cause the apparatus to:
transmit, by at least one of the TRPs and prior to the receiving, a common BFR PUCCH resource configuration for each BFR PUCCH resource of the UE wherein each BFR PUCCH resource comprises a different {periodicity, offset value} pair, wherein the receiving comprises receiving a BFR SR on a particular BFR PUCCH resource under the transmitted common BFR PUCCH resource configuration with {periodicity, offset value} pair of the particular BFR PUCCH resource.

44. The apparatus of claim 41, wherein the memory further includes instructions executable by the at least one processor to cause the apparatus to:
transmit, by at least one of the TRPs and prior to the receiving, a different BFR PUCCH resource configuration for each BFR PUCCH resource of the UE,
wherein the receiving comprises receiving a BFR SR on a particular BFR PUCCH resource under the transmitted BFR PUCCH resource configuration of the particular BFR PUCCH resource.

45.-52. (canceled)
